(19) United States
(12) Patent Application Publication
(10) Pub. No.: US 2005/0276293 A1
(43) Pub. Date: Dec. 15, 2005

(54) Teratrit processor

(76) Inventor: Sean Nicholas Greene, Baltimore, MD (US)

Correspondence Address: Sean Nicholas Greene, 660 Cokosbury Avenue, Baltimore, MD, 21218, US

(21) Appl. No.: 10/866,615

(22) Filed: Jun. 10, 2004

(51) Int. Cl. H01S 3/00

(52) U.S. Cl. 372/38.02

(57) ABSTRACT

An electrical pulse and optical photon multiplying and routing system. The system first uses a method of combining slightly identical electrical pulse signals to create a substantially smaller amount of energy to represent the same electrical signal as before only utilizing a fraction of it's previous space to allow for increased efficiency. Next the signal is applied to a laser diode to modulate the beam of light which is then modified utilizing to same method on the photonic energy as previously used on the electronic energy to further minimize the physical space used for photonic data representation and manipulation. The newly minimized optical beam is then multiplied and recombined a number of times to greatly increase the data representation rate. The signal is now split and redistributed to optical gates controlled by user defined constantly alternating photonic flow to allow and/or disallow photonic flow from user defined source

### CROSS-REFERENCE TO RELATED APPLICATIONS

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

This invention relates to optical devices, and more particularly to optical processor devices.

In the integrated circuit industry, there is a continuing effort to increase device speed and increase device densities. Optical systems are a technology that promise to increase the speed and current density of the circuits. Optical devices, such as optical interconnectors, modulators, deflectors, and lenses are components in these optical systems. Such optical devices can be used to perform a variety of functions in integrated circuits such as switching or data transmission. Optical devices that perform different functions are typically formed and shaped differently in order to perform the different functions. As such, each type of optical device, and each size of the same optical device type, has to be manufactured distinctly. Therefore, the production of precision optical devices is expensive.

### BRIEF SUMMARY OF THE INVENTION

The present invention is directed to an apparatus and associated method for increasing the speed of optical microprocessors by means of pulse cancellation, projected light over a field of optical collectors and blenders, optical gating controlled by equally fast optical instructions, a binary/trinary/quadrinary number system and condensed physical size.

### BRIEF DESCRIPTION OF THE SEVERAL VIEWS OF THE DRAWING

The accompanying drawings, which are incorporated herein and constitute part of this specification, illustrate the presently preferred embodiment of the invention, and, together with the general description given above and the detailed description given below, serve to explain features of the invention.

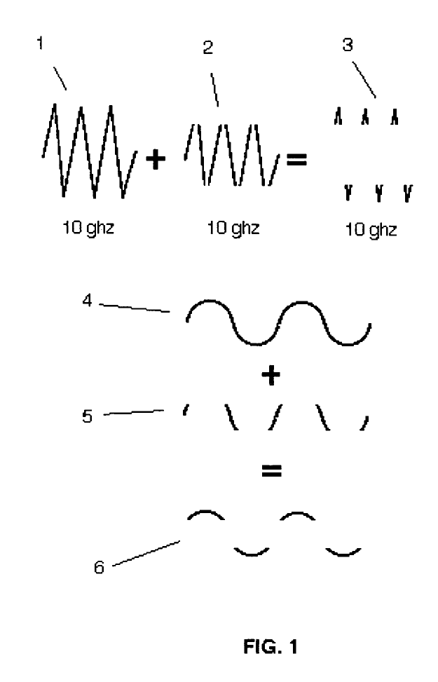

FIG. 1 shows exhibits #1 through #6
exhibit #1 shows a whole triangle pulse.
exhibit #2 shows partial “chopped off” triangle pulse.
exhibit #3 shows resulting triangle pulse when exhibits #1 & #2 are combined.
exhibit #4 shows a whole sine pulse.
exhibit #5 shows partial “chopped off” sine pulse.
exhibit #6 shows resulting sine pulse when exhibits #1 & #2 are combined.

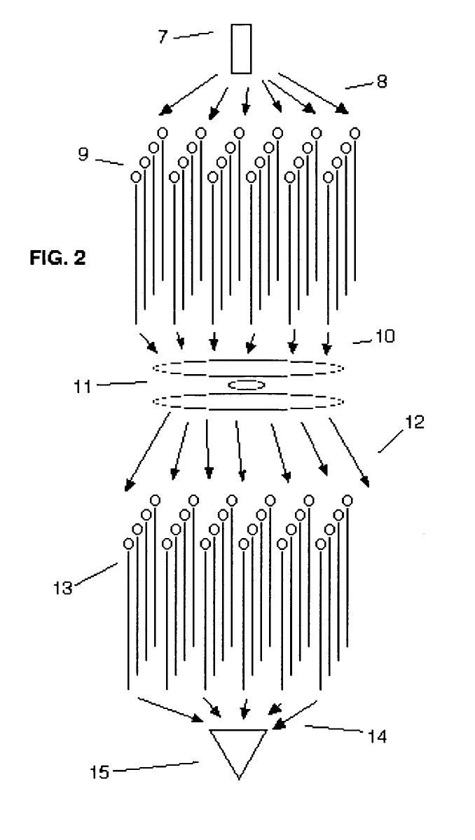

FIG. 2 shows exhibits #7 through #15
exhibit #7 shows laser diode.
exhibit #8 shows beam field projected by laser in exhibit #7.
exhibit #9 shows micro collector fibers inheriting propagation from #7.
exhibit #10 shows propagation from fibers.
exhibit #11 shows lens/blender array.
exhibit #12 shows propagation from lens/blender array.
exhibit #13 shows secondary field of micro collector fibers inheriting propagation from #11.
exhibit #14 shows secondary propagation from secondary fibers.
exhibit #15 shows secondary lens/blender.

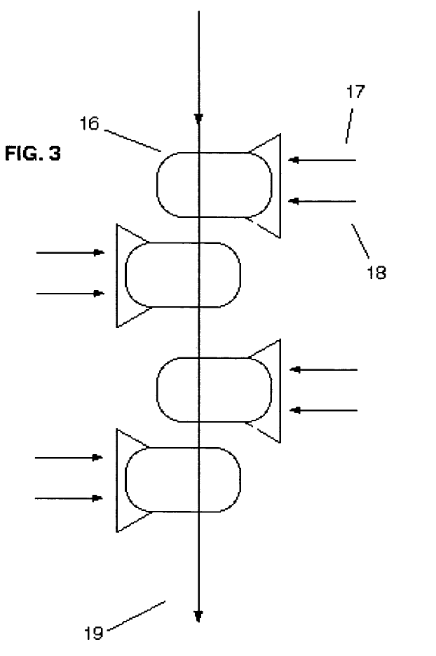

FIG. 3 shows quad optical gate array and exhibits #16 through #19
exhibit #16 shows special gate lens.
exhibit #17 shows input data propagation entering lens.
exhibit #18 shows control beam data propagation entering lens.
exhibit #19 shows altered data beam propagating gate influenced data.

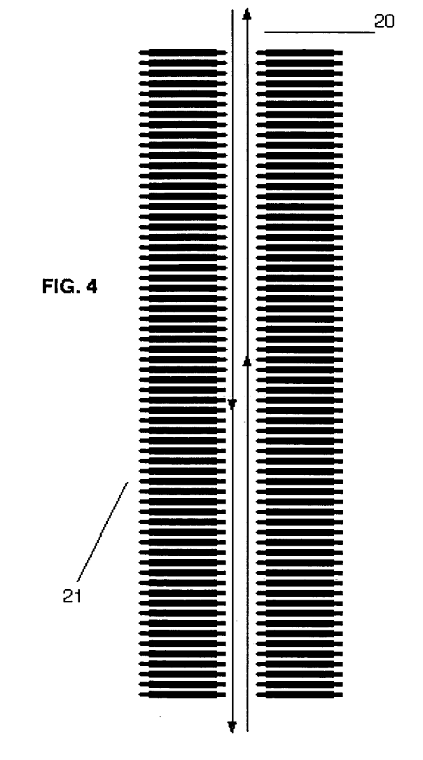

FIG. 4 shows optical matrix and exhibits #20 and #21.
exhibit #20 shows one of plurality of carrier beams propagating data in/out of matrix.
exhibit #21 shows 333 quad optical gates arranged to form matrix.

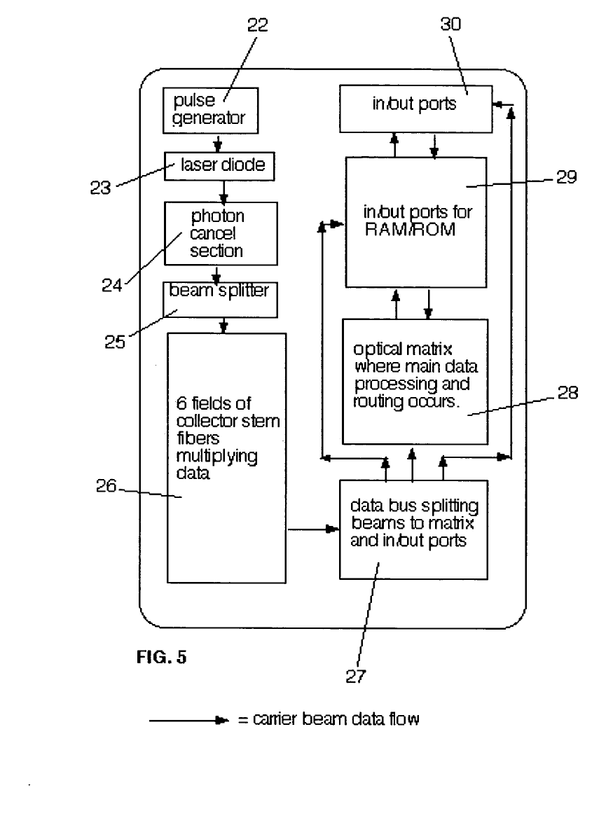

FIG. 5 shows main block diagram of complete processor as a whole and exhibits #22 through #30.
exhibit #22 shows triangle/sine pulse generator section.
exhibit #23 shows laser diode section.
exhibit #24 shows photonic canceling section.
exhibit #25 shows laser beam splitter section.
exhibit #26 shows fiber collector stem fields section.
exhibit #27 shows optical data bus section.
exhibit #28 shows optical matrix section.
exhibit #29 shows RAM/ROM in/out ports section.
exhibit #30 shows main in/out ports section to/from peripherals.

### DETAILED DESCRIPTION OF THE INVENTION

The present disclosure provides multiple embodiments of the Teratrit processor in which laser light is generated, multiplied, split, manipulated and processed. Different embodiments of processing methods are described that perform different functions to the light contained within the processor.

1. Wave Pulse Canceling

FIG. 5 exhibit #22 houses a pulse generator that outputs a primary ten gigahertz (10 ghz) pulse wave FIG. 1 exhibit #1, that is then split, doubled and combined back together with the original primary signal to form the process called “PULSE CANCELLATION” in which a secondary signal partially cancels out the primary due to the secondary pulse FIG. 1 exhibit #2 being slightly shorten by design. The result is FIG. 1 exhibit #3, a new pulse wave with same 10 ghz frequency utilizing 90% less space. FIG. 1 exhibits #4 through #6 demonstrate the same process on curved sine waves.

2. Generating Laser Photons

As shown in block diagram FIG. 5 exhibit #23 is where the laser is housed and generates its photons and then the beam is optically processed by an optical photon cancellation process that blends slightly off timed beams together to cancel out at least 80% of its photons by physical size in FIG. 5 exhibit #24 and FIG. 2 exhibit #7.

3. Multiplying Photons

As shown in FIG. 5 exhibit #25 and FIG. 2 exhibits #7 & #8 the beam is then propagated through beam splitters that split the beam into three (3) separate beams and then project those 10 ghz beams across 6 fields of at least (300) three hundred photon collector stems grouped as an array as shown in FIG. 2 exhibits #8 and #9 and block diagram FIG. 5 exhibit #26 where at the end of the collector fibers FIG. 2 exhibit 10 the propagation's flow is focused into a blender lens FIG. 2 exhibit #11 where the combined beams form one beam with a new frequency of three terahertz (3 thz). next, the same lens reprojects the 3 thz beam across a secondary field of at least (300) three hundred collector fibers FIG. 2 exhibits #11, #12 and #13 where at the end of the fibers the propagation is focused into a secondary blender lens FIG. 2 exhibits #14 and #15 where the combined beams then form one new beam with a new frequency of nine hundred terahertz (900 thz).

4. Distributing 900 thz Trinary Clock Data

As shown in block diagram FIG. 5 exhibit #27 the data now clocking at 900 thz. as routed to the optical bus where it is split and duplicated for distribution to the matrix, RAM/ROM in/out ports and external in/out ports.

5. Optical Gate

As shown in FIG. 3 exhibit #16, a lens is used to form a gate from which one side is exposed to two or more beams of data one beam being general data flow originating from an input or a command from the matrix FIG. 3 exhibit #17, the other beam being control data from the bus or matrix FIG. 3 exhibit 18 allowing the gate to open by means of imposing an opposite polarity/flow of propagation on the general data flow or closing by means of duplicating the general data flow therefore canceling out the photons in the general data flows propagation. FIG. 3 shows an array of four (quad) gates set up to be used as a dual binary, single trinary or single quadrinary gate module. Shown in FIG. 3 exhibit #19, is the newly propagated

6. Optical Matrix

As shown in FIG. 5 exhibit #28 the optical bus routes a 900 thz clock signal to the matrix that is comprised of at least 333 quad array optical gates FIG. 4 exhibit #21 that receives, manipulates and distributes data throughout all of its various ports and bus. The matrix also performs optical pulse wave addition and multiplication through routing, combining and canceling the four different pulse waves present in the main data stream by means of external instruction imposed onto the propagation of data into the processor and one or more of its carrier beams FIG. 4 exhibit #20. While the principles of the invention have been described above in connection with the specific apparatus and associated method, it is to be clearly understood that this description is made only by way of example and not as a limitation on the scope of the invention.

1. A method of reducing the physical size of a electronic pulse, wherein:
directing an electrical pulse through a splitter to double the signal
eliminating 10% (±) of original signal from only one of the identical signals
redirecting both of the signals in tandem
blending and/or combining the signals creating an out of phase result which eliminates approximately 90% (±) of original signal
remaining 10% (±) is then applied to a laser diode for propagation

2. A method of multiplying the number of photons in a beam of light, wherein:
utilizing nano fibers placed into a pattern on a given surface in which to collect and redistribute photons of light at a specified point
utilizing optical collector lens to receive and refocus photons.

3. A method of gating and controlling the photons in a beam of light, comprising:
routing 3 beams of photons into a lens assembly arranged to combine the propagation into a single beam output.
one of three beams functions as a controller beam sending contrasting photons into the lens assembly to create “in phase” and/or “out of phase” photon flow to obstruct and/or allow free photon flow from one and/or both of the other beams.
